(19) United States
(12) Patent Application Publication
(10) Pub. No.: US 2018/0024943 A1
(43) Pub. Date: Jan. 25, 2018

(54) RISK IDENTIFICATION BASED ON ADDRESS MATCHING

(71) Applicant: Alibaba Group Holding Limited, George Town (KY)

(72) Inventors: Min Xu, Hangzhou (CN); Kai Xu, Hangzhou (CN); Dijun He, Hangzhou (CN)

(73) Assignee: Alibaba Group Holding Limited, George Town (KY)

(21) Appl. No.: 15/720,410

(22) Filed: Sep. 29, 2017

Related U.S. Application Data
(63) Continuation of application No. PCT/CN2016/076883, filed on Mar. 21, 2016.

(30) Foreign Application Priority Data
Apr. 9, 2015 (CN) 201510166871.5

(51) Int. Cl. G06F 12/14; G06Q 20/34; G06F 21/57; G06F 21/34

(52) U.S. Cl. CPC G06F 12/1458; G06F 21/34; G06Q 20/34; G06F 21/577

(57) ABSTRACT

The disclosure generally describes computer-implemented methods, software, and systems for risk identification of a first address information. A computer-implemented method includes receiving a user input including identification information of a user requesting a service, processing the identification information to determine a first address coding information, retrieving a second address coding information based on the identification information, matching the first address coding information with the second address coding information to generate an address matching result, and determining a risk score based on the address matching result and a service type of the service.

This application is a continuation of PCT Application No. PCT/CN2016/076883, filed on Mar. 21, 2016, which claims priority to Chinese Patent Application No. 201510166871.5, filed on Apr. 9, 2015, the entire contents of each are hereby incorporated by reference.

### BACKGROUND

Risk identification is often performed in response to servicing processing requests. As an example, risk identification can include matching and authentication of digital information such as a credit card number, an expiration date of the credit card associated with the credit card number, a mobile phone number, and an identity number. Matching address information can be useful for risk identification. For example, a mismatch between a shipping address input by a user in a processing request and the user's credit card billing address can indicate that the current processing request might present a user identity theft risk. A common technical issue in matching address information is associated with the use of varying address formats and languages when generating and storing address information.

### SUMMARY

Implementations of the present disclosure include computer-implemented methods for matching address information for risk identification. In some implementations, actions include receiving a user input including identification information of a user requesting a service, processing the identification information to determine a first address coding information, retrieving a second address coding information based on the identification information, matching the first address coding information with the second address coding information to generate an address matching result, and determining a risk score based on the address matching result and a service type of the service.

The previously described implementation is implementable using a computer-implemented method; a non-transitory, computer-readable medium storing computer-readable instructions to perform the computer-implemented method; and a computer-implemented system comprising a computer memory interoperably coupled with a hardware processor configured to perform the computer-implemented method/the instructions stored on the non-transitory, computer-readable medium.

The foregoing and other implementations can each, optionally, include one or more of the following features, alone or in combination. In particular, one implementation can include all the following features:

A first aspect, combinable with any general implementation, includes regulating a processing operation of the service based on the risk score. In a second aspect, combinable with any of the previous aspects, the identification information includes a fuzzy identification information. A third aspect, combinable with any of the previous aspects includes, processing the fuzzy identification information to determine complete identification information. In a fourth aspect, combinable with any of the previous aspects, the address coding information includes a fraud grade associated with the identification information. In a fifth aspect, combinable with any of the previous aspects, the first address information includes a plurality of address levels. In a sixth aspect, combinable with any of the previous aspects, the address coding information includes a validity grade of the first address information that indicates an affiliation between address contents at different levels in the plurality of address levels.

The subject matter described in this specification can be implemented in particular implementations, so as to realize one or more of the following advantages. The risk identification method can be implemented and effective in risk identification based on Chinese address verification rather than an ineffective zip code. The method implementation cost is quite low as the whole work flow is based on the existent Chinese union pay transaction data structure. The overall work flow has no interference or jam for the transaction itself. Other advantages will be apparent to those of ordinary skill in the art.

The details of one or more implementations of the subject matter of this specification are set forth in the Detailed Description, the Claims, and the accompanying drawings. Other features, aspects, and advantages of the subject matter will become apparent from the Detailed Description, the Claims, and the accompanying drawings.

### DESCRIPTION OF DRAWINGS

FIG. 1 depicts an example of an architecture that can be used to execute implementations of the present disclosure.

FIG. 2 depicts an example of a component architecture in accordance with implementations of the present disclosure.

FIG. 3 is a flowchart illustrating an example of a method for matching address information for risk identification, according to an implementation of the present disclosure.

FIG. 4 is a block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

Implementations of the present disclosure are generally directed to an address authentication process to determine the risk of a user identity theft. More particularly, implementations of the present disclosure are directed to matching address coding information to provide an accurate risk identification associated to processing a request using a provided address.

Implementations can include actions of receiving a user input including identification information of a user requesting a service, processing the identification information to determine a first address coding information, retrieving a second address coding information corresponding to the identification information, matching the first address coding information with the second address coding information to generate an address matching result, and generating a risk score based on the address matching result and a service type of the service. Risk identification models can utilize address information in order to determine a risk of processing a service using the provided address information. Given that addresses can be provided in different formats, matching addresses can be a resource-intensive process that can generate unwanted errors. Implementations of the present disclosure address this challenge. For example, in accordance with implementations of the present disclosure, in order to increase the accuracy of address matching, the address information can be processed to extract address coding information that can be reliably processed by a matching algorithm.

The following detailed description is presented to enable any person skilled in the art to make and use the disclosed subject matter in the context of one or more particular implementations. Various modifications, alterations, and permutations of the disclosed implementations can be made and will be readily apparent to those or ordinary skill in the art, and the general principles defined can be applied to other implementations and applications, without departing from the scope of the present disclosure. In some instances, details unnecessary to obtain an understanding of the described subject matter can be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

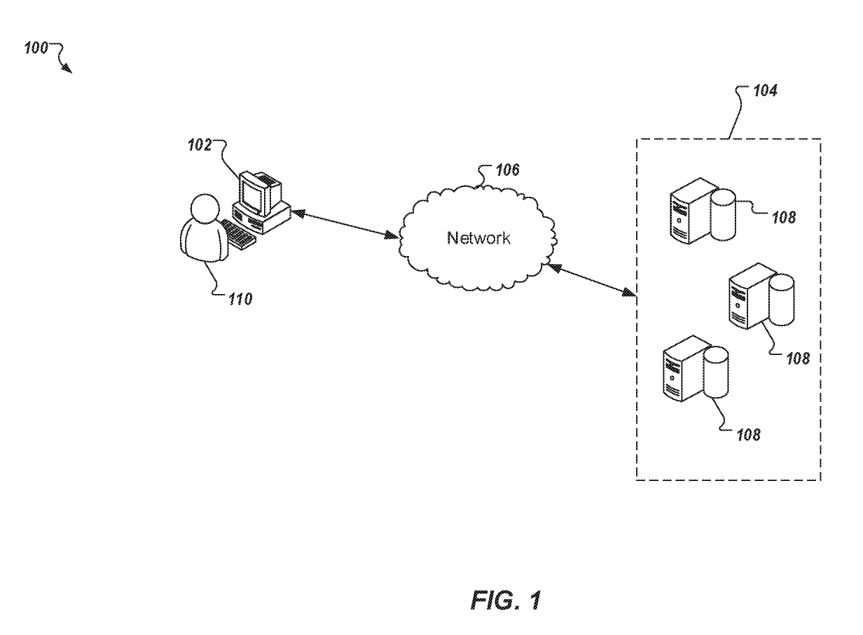

FIG. 1 depicts an example of an architecture 100 that can be used to execute implementations of the present disclosure. In the depicted example, the example architecture 100 includes one or more client devices 102, a server system 104 and a network 106. The server system 104 includes one or more server devices 108. In the depicted example, a user 110 interacts with the client device 102. In an example context, the user 110 can include a user, who interacts with a software application (or “application”) that is hosted by the server system 104.

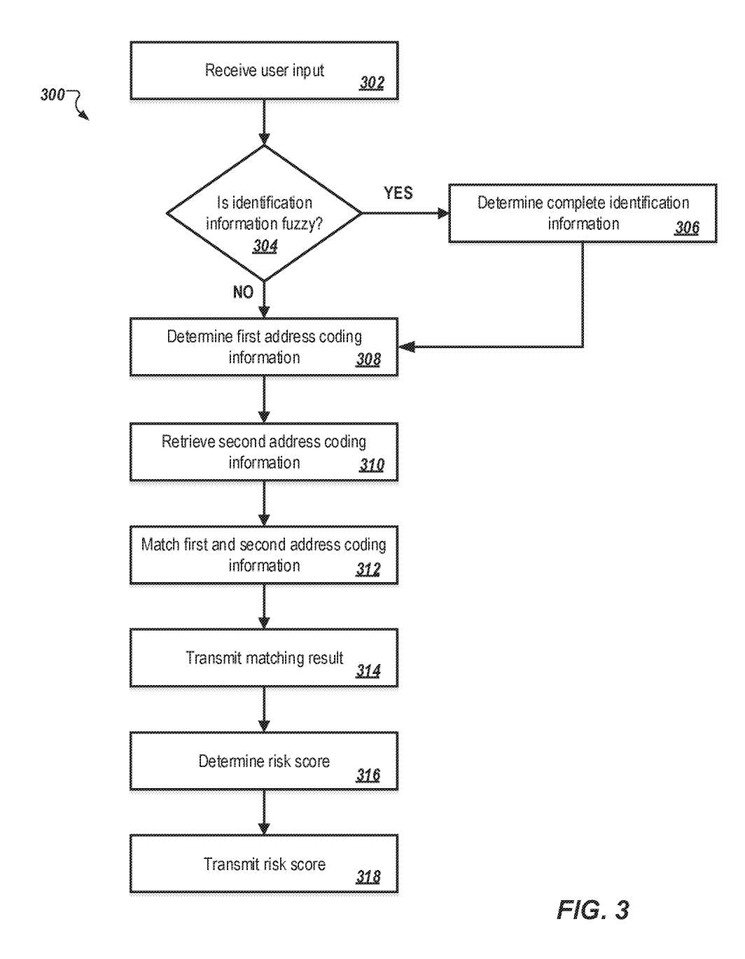

In some examples, the client device 102 can communicate with one or more of the server devices 108 over the network 106. In some implementations, the analytical web application processes the address information (for example, address coding information) received from a database or a webpage, or a combination of database and webpage, processes the address information, and processes the address information based on a particular format, before sending the address coding information to the server system 104 over the network 106. The application driver, such as a standard component of the client device 102 can be configured to perform the operations described with reference to FIG. 3.

In some implementations, each server device 108 includes at least one server and at least one data store that stores address information (such as, second address coding information). In some implementations, the server system 104 can be provided by a third-party service provider, which stores and provides access to user data including address information, credit score information, fraud information, blacklist information and other. In the example depicted in FIG. 1, the server devices 108 are intended to represent various forms of servers including, but not limited to, a web server, an application server, a proxy server, a network server, or a server pool. In general, server systems accept requests for application services (such as, pre-loan application services, purchasing orders, or online banking services) and provides such services to any number of client devices (for example, the client device 102) over the network 106.

In accordance with implementations of the present disclosure, the server system 104 can host a risk identification algorithm (for example, provided as one or more computer-executable programs executed by one or more computing devices) that can be applied before completing a service request. For example, input data including address coding information or address matching results can be provided to the server system (for example, from the client device 102), and the server system 104 can process the input data through the risk identification service to provide result data. For example, the server system 104 can send the result data to the client device 102 over the network 106 for display to the user 110.

Implementations of the present disclosure function largely independently of the browser, and do not require any modification to the browser (for example, no browser extensions or plug-ins). Further, implementations of the present disclosure support more operations than a simple search, such as filtering, resampling, matching, and risk identification, which are typical operations used in analytical applications. Implementations of the present disclosure also provide a back-end computing system with risk results associated to a user at a point in time in order to support future risk assessments.

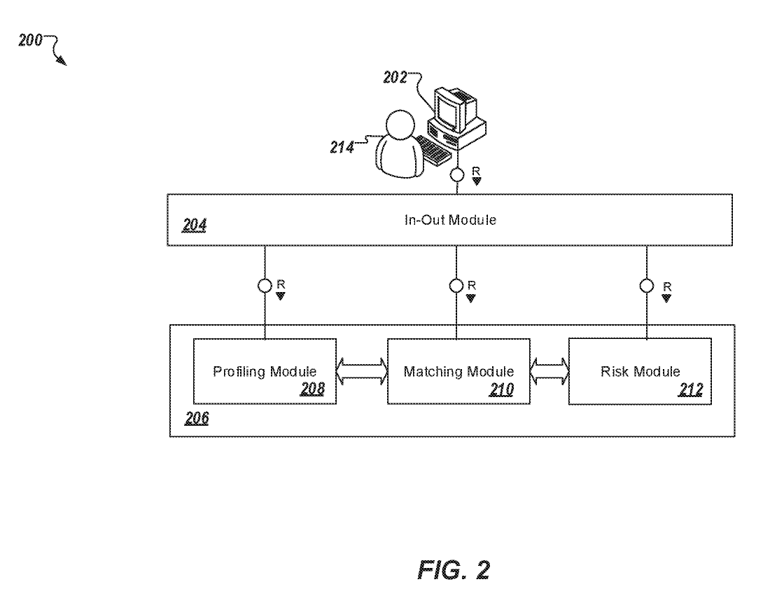

FIG. 2 depicts an example of a component architecture 200 in accordance with implementations of the present disclosure. In some implementations, components of the example architecture 200 include a client device 202 (for example, a client device 102 as described with reference to FIG. 1), an in-out module 204, and a processing system 206. The processing system 206 includes a profiling module 208, a matching module 210, and a risk module 212. In particular instances, the profiling module 208, the matching module 210, and the risk module 212 can be included in different servers. For example, the profiling module 208 can be provided on a client-side application server. In some implementations, the matching module 210 and the risk module 212 can be provided either across multiple client-side application servers or a server-side back-end computing system.

As shown in FIG. 2, the in-out module 204 is configured to communicate with the client device 202 and any module of the processing system 206 to identify risk of a service based on address matching. For example, the in-out module 204 may be configured to receive risk authentication request information, the risk authentication request information including identification information of a user who requests processing of a service and a first address. The in-out module 204 can include a communication manager that enables communication between multiple modules of the processing system, over the network 106 (for example) using one or more processors of the client 202 (102) and the server 104.

The processing system 206 can include an analyzer that is configured to analyze, calculate, and/or assess the results of each of the profiling module 208, the matching module 210, and the risk module 212. The processing system 206 can be configured to automatically transmit result data from the profiling module 208, the matching module 210, and the risk module 212 to the in-out module 204. The processing system 206 can be configured to coordinate control of a service based on particular processes performed by the profiling module 208, the matching module 210, and the risk module 212. For example, the processing system 206 can pause the processing of a service from the moment the profiling module 208 receives the identification information until the risk module 212 generates a result.

The profiling module 208 can be configured to receive identification information from the in-out module 204, to determine first address coding information, and to retrieve corresponding second address coding information stored in a database using the in-out module 204. The profiling module 208 can be configured to permit the entry or adjustment of a variety of user profiles, including address coding information. The addresses in the profile database may be created and modified by a user of a service server (such as, an employee of the service provider) using a profiling framework of the profiling module 208. The profiling module 208 can be configured to transmit the first address coding information and the second address coding information to the matching module 210.

The matching module 210 can be configured to execute a matching algorithm. The matching algorithm uses as input the first address coding information and the second address coding information and generates as output risk information including a risk score. The matching algorithm is further described with reference to FIG. 3. The risk score indicates whether the first address is consistent with the second address. The risk score is transmitted by the matching module 210 to the risk module 212.

The risk module 212 can be configured to execute a risk identification algorithm. The risk identification algorithm can receive as input the risk information and can generate as output a service risk. The risk identification algorithm is further described with reference to FIG. 3. The result of the risk identification algorithm is transmitted by the risk module 212 to the in-out module 204.

Implementations of the present disclosure are designed to increase the security of service processing based on address information. In particular, the components of the example architecture 200 have been configured to enable identification of risk associated with a service request prior to completing the request. Using risk identification prior to processing the request, eliminates any possible damages to the computing system, the network or the service provider that can be associated with the requested service.

FIG. 3 is a flowchart illustrating an example of a method 300 for matching address information for risk identification, according to an implementation of the present disclosure. Method 300 can be implemented as one or more computer-executable programs executed using one or more computing devices, as described with reference to FIGS. 1 and 2. In some implementations, various steps of the example method 300 can be run in parallel, in combination, in loops, or in any order.

At 302, a user input is received by a client-side computing device. The user input can include a request for processing a service and authentication information. The request for processing a service can include a definition of a service type (such as, purchasing service, banking service, loan or pre-loan application) and an identifier (such as, name and address) of the service provider (such as, bank, financing institution, or a supplier of services or merchandise). The authentication information includes a first address information and an identification information. The identification information can include a name, a debit or a credit card number, an expiration date of the credit card, a mobile phone number, an identity number, and any other user information. From 302, method 300 proceeds to 304.

At 304, the identification information is processed to determine whether it includes fuzzy identification information. The identification information is determined as being fuzzy if at least one type of identification information is partial (such as, incomplete) information. For example, the fuzzy identification information can include any of a fuzzy name, a fuzzy mobile phone number, a fuzzy ID number, and a fuzzy credit or debit card number. The fuzzy name can include a portion of the name (such as, a first name or a last name) and omit another portion of the name (such as, a middle name, a prefix, a suffix, a first name or a last name). The fuzzy mobile phone number can include a portion of a user mobile phone number and omit another portion (such as the area code). The fuzzy mobile phone number can have less digits than allocated to a geographical region. The fuzzy identification number can be partial numbers of the user identification number and can be customized based on application scenarios. For example, the fuzzy identification number can include only the first or last four numbers of the identification number. The fuzzy card number can include partial numbers of a user card number (such as a credit card number, a bank card number, and the like). The fuzzy card number can be customized based on application scenarios. The fuzzy card number can include the first six numbers, the last four numbers or any particular sequence of numbers of the card number. From 304, method 300 proceeds to 306 if the identification information is determined as being fuzzy, or to 308 if identification information is determined as being complete.

At 306, the fuzzy identification information is processed to determine the identification information. In some implementations, the fuzzy identification information is matched to stored profiles within an identification information database to retrieve the complete identification information. In some implementations, the missing information associated with the fuzzy identification information can be retrieved based on address information to generate the complete identification information. For example, if the fuzzy mobile phone number is missing the area code, the complete phone number can be determined by adding to the fuzzy number the area code corresponding to the city listed in the address information. From 306, method 300 proceeds to 308.

At 308, the first address information is processed to determine a first address coding information. Address coding information can be determined by digitalizing or symbolizing the address information. For example, determining address coding information can include determining address levels (such as, standardized fields) and extracting code values from the address contents at each address level. The address levels can be determined by dividing the address based on a particular format. The address can be divided into levels based on a descending order.

The address levels can include at least two levels. For example, the address levels can include a first level, which is not the lowest level and a second level that is lower than the first level. The code values can be obtained by mapping the address contents at different levels. The code values are x-position sequence numbers of equal lengths per level. For example, a geographical range corresponding to an address content at the first level can include a plurality of geographical ranges corresponding to address contents at the second level. An address code value can be generated by combining the code values corresponding to the address contents at each level of the first address.

In some implementations, the levels can include more than ten levels. The address levels can include a country name, a zip code, a province name, a city name, a district or a county name, a town or a village name, a community or neighborhood name, a street name or number, a house number, a building code or number, a unit code or number, a floor number, a room number, and a point of interest (POI). An address content at each level can be mapped to an n-bit code value. As an example, code values of different provinces or municipalities can be: Beijing: 10, Shanghai: 20, Tianjin: 30, Chongqing: 40, Heilongjiang: 11, Jilin: 12, Liaoning: 13, Inner Mongolia: 15, Hebei: 31, Shanxi: 32, Jiangsu: 21, Zhejiang: 22. The code values corresponding to the address contents of the address at each level can be sequentially arranged according to the address content ranges from large ranges to small ranges. The address coding information can include a k-position sequence number formed of the code values sequentially arranged according to the address levels n.

In some implementations, the address coding information can include a validity grade of the address information. The validity grade of the address information can be determined based on analyzing an affiliation relation between address contents at different levels in the address. The affiliation relation can be determined based on the code values corresponding to the address contents at each level in the address and a stored superior-subordinate relation between different code values. The validity grade of the address information is determined based on the affiliation relation and invalid address contents in the address, which have no corresponding relation with the code values.

It can be determined whether the affiliation relation between address contents at different levels in the address is correct based on a stored superior-subordinate relation between different code values and the code values corresponding to the address contents at each level in the address. For example, an address including the city of Shanghai with code value 20 and Changning District with code value 51 matches a superior-subordinate relation because Shanghai includes Changning District. As another example, an address including the city of Beijing with code value 10 and Changning District with code value 51 does not match a superior-subordinate relation because Beijing does not include Changning District. The output of the affiliation relation analysis can be a binary value, such as 1 (for matching superior-subordinate relations) and 0 (for non-matching superior-subordinate relations).

The validity grade of the address information can be set to be within a numerical range or it can be expressed as percentage. The numerical range can correspond to the number of address levels and the output of the affiliation relation analysis can be allocated to each respective level. For example, an address can be divided in n levels, for which the validity grade can vary between 0 and n. A validity grade of n can indicate that all n levels correctly match the superior-subordinate relations so that all relations are valid. A validity grade of n-m can indicate that m levels did not match the superior-subordinate relations so that only n-m relations are valid. A validity grade of 0 can indicate that no levels match the superior-subordinate relations so that no relations are valid.

In some implementations, the address coding information can include a fraud grade of the address information. The fraud grade of the address information can be determined based on information indicating fraud cases related to the first address within a first time interval, the number of fraud cases related to the first address within a second time interval that is longer than the first time interval, a ratio of fraud cases related to the first address relative to a total number of fraud cases per service provider or per geographical region or an association between the user generating the request and a user identified as performing frauds. A fraud grade of 0 can indicate that no fraud information was found to be associated with any portion of the identification information. A fraud grade larger than 0 can indicate that a fraud information was found to be associated with a portion of the identification information. In some implementations, for each fraud information identified as being associated with a portion of the identification information, the fraud grade can be increased with a unit.

In some implementations, the address coding information can include a server risk grade. The server risk grade includes information indicating number of server terminals through which the user applies for services within a particular time interval. In some implementations, the address coding information can include a blacklist identifier. The blacklist identifier includes information indicating whether the user has an association with a blacklist user who has a bad credit record. From 308, method 300 proceeds to 310.

At 310, a second address coding information used for identifying a second address is retrieved based on the user information. The second address coding information can be retrieved from a database configured to store address coding information for a plurality of users. For example, the first address can be a logistic shipping address provided by the user during online transaction and the second address can be a billing address (for example, a home address, a work, a mailing address or the like) provided by the service server terminal (such as, a bank). As another example, if the service requested to be processed by the user is a pre-loan application or online application crediting service, the first address can be a billing address of the user provided by the service server terminal (such as, a bank) and the second address can include portions of address information of the user retrieved from the user information data base. As another example, if the service requested to be processed by the user is a network transaction service and the server itself for performing risk identification in the embodiment of the present application is a service server terminal, the first address can be a logistic shipping address provided by the user and the second address can be a billing address stored and provided by the server for performing risk identification. From 310, method 300 proceeds to 312.

At 312, a matching algorithm is applied to the first and second address coding information. The matching algorithm can include one or more statistical algorithms (for example, correlation functions) that are applied to the k-position sequence numbers corresponding to the first and second address coding information. The matching algorithm can be configured to compare the code values of the two addresses that correspond to the same level. In some implementations, the matching algorithm can be configured to perform a comparison of code values corresponding to a portion of the total number of address levels that are defined as relevant levels without considering the remaining address levels that are defined as optional. The matching algorithm can be configured to evaluate the optional portions of the addresses for conflicts.

The matching algorithm determines the risk level based on address availability and risk features. The address availability is defined for six levels (for example, from values 0 to 5) that can be graded. The address availability is defined by comparing the transaction input address with the standardized address. The risk features considered by the matching algorithm can include one or more of the following: whether the card holder is included in a black list; whether the card holder is first degree relationship with the black list or fraudulent in the past year; fraud history of the card holder; total number of institutes that the card holder applies for within a time interval; whether any fraud case happened related to the address; and the number, amount and ratio of the fraud cases happened in the past year related to the address. For each risk feature that satisfies the condition, the level is increased by 1. For each risk feature that does not satisfy the condition, the level remains constant or zero. The address availability level can be added into an address verification risk method to generate a final score for the risk level identification.

The output of the matching algorithm can be a numerical value (such as, percentages or as a number ranging from 0 to 1). An output with a maximum numerical value can indicate that the second address coding information is consistent with the first address coding information. An output with the maximum numerical value can be generated if the first address coding information and the second address coding information are completely identical, or a portion of the first address coding information and the second address coding information is the same while the remaining portion of coding information is not in conflict. For example, the first address coding information indicates that the first address is Chaoyang District, Beijing, the second address coding information indicates that the second address is Shaoyaojubeili, Chaoyang District, Beijing. Within the context example, a relevant portion of the first address coding information (Chaoyang District, Beijing) is the same as the corresponding relevant portion of the second address coding information and the address content “Shaoyaojubeili,” identified as an optional portion within the second address coding information, is not in conflict with the first address coding information. From 312, method 300 proceeds to 314.

At 314, the output of the matching algorithm is transmitted to be used as an input for a risk identification algorithm. From 314, method 300 proceeds to 316. At 316, a risk identification algorithm is performed using the address matching result to determine a risk information for the service requested by the user. Determining a risk information includes inputting the address matching result into a risk model and performing risk identification on the service type requested by the user according to an output result from the risk model. The server receives the value of the address matching result sent by the client and uses it as an input for the risk identification model. The address matching result can be processed by a processor of the client device or the server, utilizing a risk identification model stored at the client device or at the client, respectively to perform risk identification. For example, the risk identification model can process the address matching result to generate a risk information using a risk identification rule. The risk information can include a risk score and a risk category. The risk score can indicate a level of risk associated to the requested service type. The risk score can be a numerical value or a qualitative value (for example, low risk, medium risk and high risk). The risk categories can indicate the type of risk that is associated with the requested service type. The risk categories can include network service risk, data risk, user risk, device risk, business risk, and legal risk.

The risk identification rule can use as input the address matching result and the service type. In some implementations, the risk identification rule can include comparing the address matching result to one or more particular thresholds based on the service type to determine the risk score. As an example, the threshold can depend on the type of requested service, the mathematical function used to determine the address matching result or other parameters. An application score threshold can be defined as low, medium or high risk. Low risk can be given for a total number of institutes that the applicant applied within a time interval (such as, 1 month or 1 year) that is smaller than or equal to 2. Medium risk can be given for a total number of institutes that the applicant applied within a time interval (such as, 1 month or 1 year) that is larger than 2, but smaller than 5. High risk can be given for a total number of institutes that the applicant applied within a time interval (such as, 1 month or 1 year) that is larger than or equal to 5. The address verification risk score can be graded (such as, from 0 to 10). A higher address verification score can be indicative of lower risk. From 316, method 300 proceeds to 318.

At 318, the risk score is transmitted to the service terminal for regulating a processing operation of the service. In some implementations, the service server is configured to perform operations that include a risk prevention and control by applying a corresponding risk prevention rule. If the risk score indicates a low risk associated with the service, the service processing can be completed. If the risk score indicates a medium or a high risk associated with the service, the service processing can be controlled, regulated or blocked based on the service type. In some implementations, in response to blocking the service, the risk information can be displayed or an alert can be issued. In some implementations, the alert can trigger one or more post-processing operations to identify client device functions associated with the risk that triggered the alert. In some implementations, the post-processing operations can include removing the risk (blocking a service) associated with the high risk and displaying a message associated with the risk. During processing operations, if a risk alert is issued, the card issue bank can call the merchant for risk appeal. During risk appeal, the transaction can be frozen or rejected. After 318, method 300 stops.

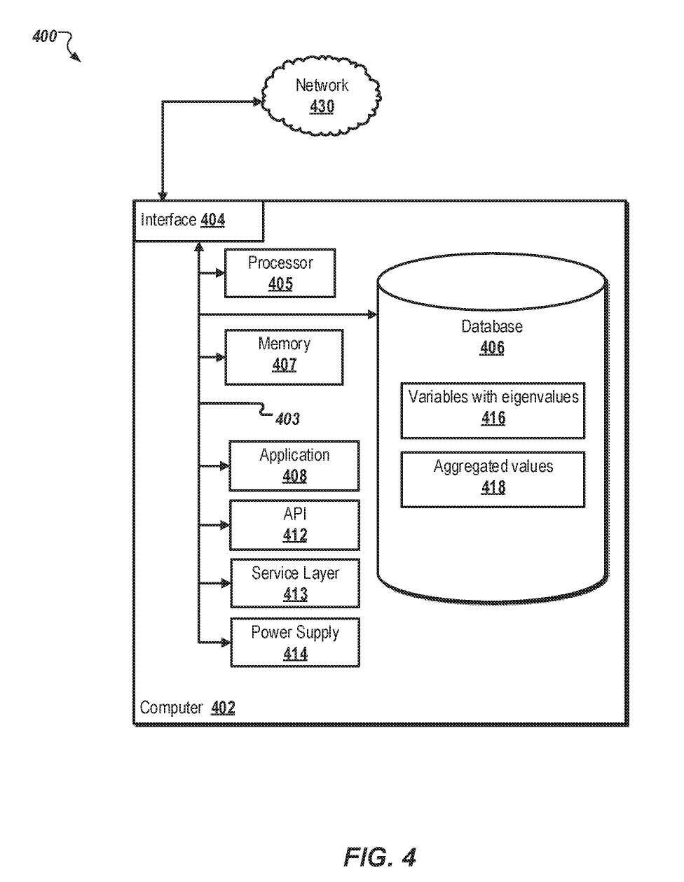

FIG. 4 is a block diagram illustrating an example of a computer system 400 used to provide computational functionalities associated with described algorithms, methods, functions, processes, flows, and procedures, according to an implementation of the present disclosure. The illustrated computer 402 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 402 can comprise a computer that includes an input device, such as a keypad, keyboard, touch screen, another input device, or a combination of input devices that can accept user information, and an output device that conveys information associated with the operation of the computer 402, including digital data, visual, audio, another type of information, or a combination of types of information, on a graphical-type user interface (UI) (or GUI) or other UI.

The computer 402 can serve in a role in a computer system as a client, network component, a server, a database or another persistency, another role, or a combination of roles for performing the subject matter described in the present disclosure. The illustrated computer 402 is communicably coupled with a network 430. In some implementations, one or more components of the computer 402 can be configured to operate within an environment, including cloud-computing-based, local, global, another environment, or a combination of environments.

At a high level, the computer 402 is an electronic computing device operable to receive, transmit, process, store, or manage data and information associated with the described subject matter. According to some implementations, the computer 402 can also include or be communicably coupled with a server, including an application server, e-mail server, web server, caching server, streaming data server, another server, or a combination of servers.

The computer 402 can receive requests over network 430 (for example, from a client software application executing on another computer 402) and respond to the received requests by processing the received requests using a software application or a combination of software applications. In addition, requests can also be sent to the computer 402 from internal users (for example, from a command console or by another internal access method), external or third-parties, or other entities, individuals, systems, or computers.

Each of the components of the computer 402 can communicate using a system bus 403. In some implementations, any or all of the components of the computer 402, including hardware, software, or a combination of hardware and software, can interface over the system bus 403 using an application programming interface (API) 412, a service layer 413, or a combination of the API 412 and service layer 413. The API 412 can include specifications for routines, data structures, and object classes. The API 412 can be either computer-language independent or dependent and refer to a complete interface, a single function, or even a set of APIs. The service layer 413 provides software services to the computer 402 or other components (whether illustrated or not) that are communicably coupled to the computer 402. The functionality of the computer 402 can be accessible for all service consumers using this service layer. Software services, such as those provided by the service layer 413, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 402, alternative implementations can illustrate the API 412 or the service layer 413 as stand-alone components in relation to other components of the computer 402 or other components (whether illustrated or not) that are communicably coupled to the computer 402. Moreover, any or all parts of the API 412 or the service layer 413 can be implemented as a child or a sub-module of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402. The interface 404 is used by the computer 402 for communicating with another computing system (whether illustrated or not) that is communicatively linked to the network 430 in a distributed environment. Generally, the interface 404 is operable to communicate with the network 430 and comprises logic encoded in software, hardware, or a combination of software and hardware. More specifically, the interface 404 can comprise software supporting one or more communication protocols associated with communications such that the network 430 or interface's hardware is operable to communicate physical signals within and outside of the illustrated computer 402.

The computer 402 includes a processor 405. Although illustrated as a single processor 405 in FIG. 4, two or more processors can be used according to particular needs, desires, or particular implementations of the computer 402. Generally, the processor 405 executes instructions and manipulates data to perform the operations of the computer 402 and any algorithms, methods, functions, processes, flows, and procedures as described in the present disclosure.

The computer 402 also includes a database 406 that can hold data for the computer 402, another component communicatively linked to the network 430 (whether illustrated or not), or a combination of the computer 402 and another component. For example, database 406 can be an in-memory, conventional, or another type of database storing data consistent with the present disclosure. In some implementations, database 406 can be a combination of two or more different database types (for example, a hybrid in-memory and conventional database) according to particular needs, desires, or particular implementations of the computer 402 and the described functionality. Although illustrated as a single database 406 in FIG. 4, two or more databases of similar or differing types can be used according to particular needs, desires, or particular implementations of the computer 402 and the described functionality. While database 406 is illustrated as an integral component of the computer 402, in alternative implementations, database 406 can be external to the computer 402. As illustrated, the database 406 holds previously described variables with eigenvalues 416 and aggregated data 418.

The computer 402 also includes a memory 407 that can hold data for the computer 402, another component or components communicatively linked to the network 430 (whether illustrated or not), or a combination of the computer 402 and another component. Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 or similar or differing types can be used according to particular needs, desires, or particular implementations of the computer 402 and the described functionality. While memory 407 is illustrated as an integral component of the computer 402, in alternative implementations, memory 407 can be external to the computer 402.

The application 408 is an algorithmic software engine providing functionality according to particular needs, desires, or particular implementations of the computer 402, particularly with respect to functionality described in the present disclosure. For example, application 408 can serve as one or more components, modules, or applications. Further, although illustrated as a single application 408, the application 408 can be implemented as multiple applications 408 on the computer 402. In addition, although illustrated as integral to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion or management circuits (including recharging, standby, or another power management functionality). In some implementations, the power-supply 414 can include a power plug to allow the computer 402 to be plugged into a wall socket or another power source to, for example, power the computer 402 or recharge a rechargeable battery.

There can be any number of computers 402 associated with, or external to, a computer system containing computer 402, each computer 402 communicating over network 430. Further, the term “client,” “user,” or other appropriate terminology can be used interchangeably, as appropriate, without departing from the scope of the present disclosure. Moreover, the present disclosure contemplates that many users can use one computer 402, or that one user can use multiple computers 402.

Described implementations of the subject matter can include one or more features, alone or in combination.

For example, in a first implementation, a computer-implemented method for risk identification of a first address information that is executed by one or more processors includes: receiving, by the one or more processors, a user input including identification information of a user requesting a service, processing, by the one or more processors, the identification information to determine a first address coding information, retrieving, by the one or more processors, a second address coding information based on the identification information, matching, by the one or more processors, the first address coding information with the second address coding information to generate an address matching result, and determining, by the one or more processors, a risk score based on the address matching result and a service type of the service.

The foregoing and other described implementations can each, optionally, include one or more of the following features:

A first feature, combinable with any of the following features, includes regulating a processing operation of the service based on the risk score.

In a second feature, combinable with any of the previous features, the identification information includes a fuzzy identification information.

A third feature, combinable with any of the previous features includes, processing the fuzzy identification information to determine complete identification information.

In a fourth feature, combinable with any of the previous features, the address coding information includes a fraud grade associated with the identification information.

In a fifth feature, combinable with any of the previous features, the first address information includes a plurality of address levels.

In a sixth feature, combinable with any of the previous features, the address coding information includes a validity grade of the first address information that indicates an affiliation between address contents at different levels in the plurality of address levels.

In a second implementation, a non-transitory, computer-readable medium storing one or more instructions executable by a computer system to perform operations includes: receiving a user input including identification information of a user requesting a service, processing the identification information to determine a first address coding information, retrieving a second address coding information based on the identification information, matching the first address coding information with the second address coding information to generate an address matching result, and determining a risk score based on the address matching result and a service type of the service.

The foregoing and other described implementations can each, optionally, include one or more of the following features:

A first feature, combinable with any of the following features, includes regulating a processing operation of the service based on the risk score.

In a second feature, combinable with any of the previous features, the identification information includes a fuzzy identification information.

A third feature, combinable with any of the previous features includes, processing the fuzzy identification information to determine complete identification information.

In a fourth feature, combinable with any of the previous features, the address coding information includes a fraud grade associated with the identification information.

In a fifth feature, combinable with any of the previous features, the first address information includes a plurality of address levels.

In a sixth feature, combinable with any of the previous features, the address coding information includes a validity grade of the first address information that indicates an affiliation between address contents at different levels in the plurality of address levels.

In a third implementation, a computer-implemented system, includes: one or more computers, and one or more computer memory devices interoperably coupled with the one or more computers and having tangible, non-transitory, machine-readable media storing instructions, that when executed by the one or more computers, perform operations including: receiving a user input including identification information of a user requesting a service, processing the identification information to determine a first address coding information, retrieving a second address coding information based on the identification information, matching the first address coding information with the second address coding information to generate an address matching result, and determining a risk score based on the address matching result and a service type of the service.

The foregoing and other described implementations can each, optionally, include one or more of the following features:

A first feature, combinable with any of the following features, includes regulating a processing operation of the service based on the risk score.

In a second feature, combinable with any of the previous features, the identification information includes a fuzzy identification information.

A third feature, combinable with any of the previous features includes, processing the fuzzy identification information to determine complete identification information.

In a fourth feature, combinable with any of the previous features, the address coding information includes a fraud grade associated with the identification information.

In a fifth feature, combinable with any of the previous features, the first address information includes a plurality of address levels.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or another unit for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual modules that implement described features and functionality using various objects, methods, or other processes, the programs can instead include a number of sub-modules, third-party services, components, libraries, and such, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what can be claimed, but rather as descriptions of features that can be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method for risk identification of a first address information, the method being executed by one or more processors and comprising:
receiving, by the one or more processors, a user input comprising identification information of a user requesting a service;
processing, by the one or more processors, the identification information to determine a first address coding information;
retrieving, by the one or more processors, a second address coding information based on the identification information;
matching, by the one or more processors, the first address coding information with the second address coding information to generate an address matching result; and
determining, by the one or more processors, a risk score based on the address matching result and a service type of the service.

2. The method of claim 1, further comprising regulating a processing operation of the service based on the risk score.

3. The method of claim 1, wherein the identification information comprises a fuzzy identification information.

4. The method of claim 3, further comprising processing the fuzzy identification information to determine complete identification information.

5. The method of claim 1, wherein the address coding information comprises a fraud grade associated with the identification information.

6. The method of claim 1, wherein the first address information comprises a plurality of address levels.

7. The method of claim 7, wherein the address coding information comprises a validity grade of the first address information that indicates an affiliation between address contents at different levels in the plurality of address levels.

8. A non-transitory, computer-readable medium storing one or more instructions executable by a computer system to perform operations comprising:
receiving a user input comprising identification information of a user requesting a service;
processing the identification information to determine a first address coding information;
retrieving a second address coding information based on the identification information;
matching the first address coding information with the second address coding information to generate an address matching result; and
determining a risk score based on the address matching result and a service type of the service.

9. The non-transitory, computer-readable medium of claim 8, further performing operations comprising regulating a processing operation of the service based on the risk score.

10. The non-transitory, computer-readable medium of claim 8, wherein the identification information comprises a fuzzy identification information.

11. The non-transitory, computer-readable medium of claim 10, further performing operations comprising processing the fuzzy identification information to determine complete identification information.

12. The non-transitory, computer-readable medium of claim 8, wherein the address coding information comprises a fraud grade associated with the identification information.

13. The non-transitory, computer-readable medium of claim 8, wherein the first address information comprises a plurality of address levels.

14. The non-transitory, computer-readable medium of claim 13, wherein the address coding information comprises a validity grade of the first address information that indicates an affiliation between address contents at different levels in the plurality of address levels.

15. A computer-implemented system, comprising:
one or more computers; and
one or more computer memory devices interoperably coupled with the one or more computers and having tangible, non-transitory, machine-readable media storing instructions, that when executed by the one or more computers, perform operations comprising:
receiving a user input comprising identification information of a user requesting a service;
processing the identification information to determine a first address coding information;
retrieving a second address coding information based on the identification information;
matching the first address coding information with the second address coding information to generate an address matching result; and
determining a risk score based on the address matching result and a service type of the service.

16. The method of claim 15, wherein the operations further comprise regulating a processing operation of the service based on the risk score.

17. The method of claim 15, wherein the identification information comprises a fuzzy identification information.

18. The method of claim 17, wherein the operations further comprise processing the fuzzy identification information to determine complete identification information.

19. The method of claim 15, wherein the address coding information comprises a fraud grade associated with the identification information.

20. The method of claim 15, wherein the first address information comprises a plurality of address levels.
